(19) United States
(12) Patent Application Publication
(10) Pub. No.: US 2003/0189495 A1
(43) Pub. Date: Oct. 9, 2003

(54) Method and system for controlling a selected electrical load in a building

(76) Inventors: Peter R. Pettler, Nevada City, CA (US); Laurence R. Nicholson, Nevada City, CA (US); Michael J. Barford, Lindenwold, NJ (US); Michael J. Hardy, San Diego, CA (US); Mark A. Gilmore, Decatur, TN (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/114,845

(22) Filed: Apr. 3, 2002

(51) Int. Cl. G01V 3/00

(52) U.S. Cl. 340/854.3; 340/853.3; 340/310.01

(57) ABSTRACT

Energy dissipating loads are controlled from a location remote from the load. Load control information is transmitted between the remote location and the load by way of electrical energy transmission lines including a neutral conductor, a ground conductor and a line conductor. Load control information representative of the electrical energy applied to the load is determined and the load control information and applied to the energy transmission lines at an impressing end for transmission to a receiving end wherein the load control information is impressed between the neutral conductor and the ground conductor to provide impressed load control information. The impressed load control information is received at the receiving end by obtaining the load control information from between the neutral conductor and the ground conductor to provide received load control information. The energy of the load is controlled in accordance with the received load control information.

### BACKGROUND OF THE INVENTION

It is well known to transmit data over power line communications systems. For example, U.S. Pat. No. 5,828,293, entitled Data Transmission Over A Power Line Communications System, issued to Rickard, teaches a power line communication system wherein varying noise levels in the system are used to determine the timing of the transmission of data packets being transmitted over the system. U.S. Pat. No. 4,611,274, entitled Data Transmission System Via Power Supply Line, issued to Machino, et al. teaches the transmission of a high frequency AC signal mixed with an AC commercial frequency signal for the purpose of transmitting information.

Many other ways of applying the signal to a transmission line are also known. For example in U.S. Pat. No. 5,815,067, entitled Single Control Wire Device For HID Dimming, issued to Knoble, et al., teaches providing a multi-phase power system with an additional control wire for the control of a dimming function by transmission of a control signal over the control wire. U.S. Pat. No. 5,694,108, entitled Apparatus and Methods for Power Network Coupling, issued too Shuey, teaches establishing communications between geographically separated electronic devices using an utility distribution network by coupling the transmitting and receiving components between line and ground. U.S. Pat. No. 5,489, 809, entitled Power Control Unit for Electronic Device, issued to Kaya, et al., teaches connecting electronic devices through a communication cable to permit a power control unit to operate a power supply through the communication cable by applying a control signal thereto over the cable.

U.S. Pat. No. 5,495,406, entitled Load Control System, issued to Kushiro, et al., teaches providing power line carrier communication signals in accordance with control signals and transmitting the power line carrier communication signals through branch power lines and through transmission lines. U.S. Pat. No. 4,016, 429, entitled Power Line Carrier Communication System for Signaling Customer Locations Through Ground Wire Conductors, issued to Vercellotti, et al., teaches impressing carrier current signals onto grounding conductors connected to the power system and real earth ground. In U.S. Pat. No. 3,971,010, entitled Ballasted Load Control System and Method, issued to Foehn, teaches controlling the energizing of ballasted loads by superimposing radio frequency control signals onto power circuits which supply power to the loads.

It is also known for a controlled load to transmit control signals to a load controller by way of the same carrier line transmission methodology used to apply control signals from the load controllers to the loads. For example, U.S. Pat. No. 5,694,109, entitled Two-Wire DC Communication System and Transceiver, issued to Nguyen, et al., teaches signaling between transceivers over a single pair of conductors wherein the controller can receive sensor data from the load devices. Additionally, U.S. Pat. No. 5,475,360, entitled Power Line Carrier Controlled Lighting System, issued to Guidette, et al., teaches a system having sensors wherein both sensor information and control signal information are transmitted over a carrier signal line.

Furthermore, it is known to permit controllers to addressably select loads for control, and to addressably select groups of loads for control. U.S. Pat. No. 4,213,182, entitled Programmable Energy Load Controller System and Methods, issued to Eichelberger, et al., teaches a central facility in communication with a plurality of remotely located processors configured with a unique address for selectively energizing loads coupled to each processor under the control of the central facility. U.S. Pat. No. 3,702,460, entitled Communications System for Electric Power Utility, issued to Blose, teaches a plurality of geographically distributed group control units transmitting information by coded signals to the terminal processors units.

However, the known prior art suffers from the fact that each of the controlled loads acts as a dissipative shunt path for the high frequency control signals. This results in inefficient coupling and excessive propagation losses for the transmitted control signals. Additionally, the apparent impedance of the branch circuits to high frequency control signals changes whenever various loads that it supplies are switched onto, or disconnected from the branch. Such impedance variations preclude optimum control signal energy transfer to the power mains. Also, any electrical noise that is produced by the various types of electrical loads conducted to the branch tend to corrupt the control signals and increase the probability of transmission errors. Finally, conventional systems using the line and ground conductors as a signal path suffer from the fact that branch circuits served by different phases of the distribution transformer are separate are isolated from each other for the high frequency control signal. They require special coupling techniques to permit propagation of the control signals between the phases.

### SUMMARY OF THE INVENTION

In a system including a plurality of energy dissipating loads a method is taught for controlling from a location remote from the load the amount of electrical energy applied to the load wherein load control information is transmitted between the remote location and the load by way of a plurality of electrical energy transmission lines including a neutral conductor, a ground conductor and a line conductor. The method includes determining load control information representative of the electrical energy applied to the load and applying the load control information to the energy transmission lines at an impressing end of the energy transmission lines for transmission to a receiving end of the energy transmission lines wherein the load control information is impressed between the neutral conductor and the ground conductor of the energy transmission lines to provide impressed load control information. The impressed load control information is received at the receiving end of the energy transmission lines by obtaining the load control information from between the neutral conductor and the ground conductor to provide received load control information. The energy of the load is controlled in accordance with the received load control information. The impressing end of the plurality of electrical energy transmission lines can include a host computer for performing control protocols to control the energy dissipation of the load while the receiving end of the plurality of energy transmission lines can include a responder for obtaining the impressed load control information to control the energy dissipation of the load. Alternately, the impressing end of the plurality of energy transmission lines can include a responder for receiving a voltage signal by the responder representative of a status associated with the load while the receiving end of the plurality of energy transmission lines can include a host computer for performing the control operations to control the energy of the load.

### DESCRIPTION OF THE DRAWINGS

FIG. 1 is a schematic representation of the system for controlling a selected electrical load in a building of the present invention.

FIG. 2 is a more detailed schematic representation of a portion of the system for controlling a selected electrical load in a building of FIG. 1.

FIG. 3 is a more detailed representation of a controller/responder suitable for use in the system for controlling a selected electrical load in a building of FIG. 1.

FIG. 4 is a more detailed representation of a transceiver suitable for use in the system for controlling a selected electrical load in a building of FIG. 1.

FIG. 5 is a more detailed representation of the responder suitable for use in the system for controlling a selected electrical load in a building of FIG. 1.

### GENERAL DESCRIPTION OF THE INVENTION

The system of the present invention consists of a single power line modem, multiple slave responder controllers, and optional slave repeaters. Multiple systems may be operated together in a multi-drop configuration of multiple power line modems. The power line modem is generally connected between a host computer system and the power line A responder controller is connected at each light fixture or other device to be controlled. A slave repeater is used to repeat all transmissions to the extend range of the system.

The host computer is responsible for generating the specific commands and addresses to control the system. The data from the host is translated to the protocol of the invention by the power line modem and transmitted over the power lines. All responder controllers listen to the data on the power line at all times. Each responder has a unique address. When the responder receives an address that agrees with its assigned address, then the host computer command is recognized.

The system of the present invention supports group and global addressing to either sets of responder controllers or to all responder controllers. These addressing modes permit fast execution of control schemes involving multiple loads. Responders can also transmit messages to the power line modem and host computer in order to send data or status.

In order to improve system reliability, redundancy may be used wherein either a second host computer or a second smart power line modem is used. If an event is detected by the redundant device but not properly responded to by the primary master device, the redundant device can send the correct messages. The redundancy system does not have to affect the system protocol.

The system protocol is adapted to provide efficient and flexible power control. The intent is to allow the user to re-configure the system from the host computer without physical access to each responder controller. The system protocol also contains various error checking and correction schemes. These schemes improve system reliability in a noisy power environment.

The system protocol does not require handshaking between the power line modem and the various responders. This permits group addressing without handshake conflicts. In one preferred embodiment the system is unidirectional, with communication traveling only from the power line modem to the responders. However, the protocol includes provisions for responder responses returned back to the power line modem. The protocol also includes provision for random transmission of data from a responder back to the power line modem.

Addressing and groups in the system protocol are directly related to one another, where addresses correspond to individual responder units, and groups correspond to combinations of those individual units. The system protocol supports a large number of individually addressed responder units and, in one preferred embodiment, at least 1024 groups.

Thus, a group is a logical area or zone made up of a number of individual units. A group can even consist of several smaller groups that each contain multiple responders. This allows all responder unit addresses to remain the same regardless of which groups they are in. For example, if an office building is remodeled and lighting zones with the building are changed, the responders are simply re-assigned to different groups. There is no need to change the individual addresses of the responders. Since each responder in the system can be assigned to many groups, a responder can be re-configured from the host computer to correspond to the new office layout, while maintaining its knowledge of system-wide control schemes, such as setting an entire floor to half brightness.

To set up a group of smaller groups in a preferred embodiment, the “ASSIGN TO GROUP” command is sent to the smaller group, with the group assignment being the “master” group. All responders already included in the smaller group will add the “master” group to its list. Subsequent commands to the “master” group will activate all responders in that group.

Area addressing implies a super group comprised of certain individual responders or groups of responders which may be controlled in unison. For example, all of the fixtures on an entire floor of a building which might be required to be illuminated simultaneously in the event of an emergency can be provided with area addressing. Area addressing has a predetermined number of responders that can be grouped together, whereas a group can combine virtually any number of responders.

In a preferred embodiment of system of the invention each message can have a 11 bit address field, which could be described as follows:

| D10 | D9 D8 D7 D6 D5 D4 D3 D2 D1 D0 |
|---|---|
| Unit/Group | Unit or Group Address Number |

Unit/Group = 0, address is unit address (maximum of 1024 units)
Unit/Group = 1, address is group address (maximum of 1024 groups)
Group Address 0x3FF is special system wide address (all responders respond)

The unique address of each responder can be programmed before installation or at the time of installation. In order to program it at the time of installation a programming button on the responder is pressed. Then a SET ADDRESS command with the correct address is transmitted and the new address is recorded. Several responders can have the same address if they are intended to always operate together. With 1024 addresses, this is probably not necessary and would reduce flexibility.

The power line modem of the system of the invention is provided with an implied address as defined by the direction bit. The address structure does not support a specific power line modem address.

The system protocol has provision for scenes, or special combinations of various circuits or lights, being at various levels. The addressing may done to an individual responder unit, a group, or to all units in the system that are included in the scene. The latter is the most common form of scene addressing. The system can support a total of up to 128 or more scenes in one embodiment.

Each responder or group of responders is first set to specific levels, including an off level if desired, using either instant on/off commands or fade commands. The responder unit or group of responders is assigned to a scene. Each responder records the current level setting and the most recent fade speed as the value for that particular scene. Each responder or group can be assigned to multiple scenes.

When the system computer issues a “Go To Scene” command, each addressed unit checks its list of scenes. If the scene is included in the list of a responder unit, the responder unit fades or negative fades to the previously recorded level. If the scene is not in the responder unit list, the command from the computer is ignored. This allows very powerful control over the system, instantly controlling large sets of lights to varying degrees of brightness, on, or off, all at the same time.

When a command message is received from the system host computer by the power line modem the power line modem re-formats the data in order to provide a format suitable for transmission to the responders. Likewise, responders may also transmit message frames to the power line modem.

Messages are transmitted a second time a prescribed amount of time after the first message frame is sent according to predetermined timing definitions. This permits correction of errors if the first transmission is faulty. The host computer is responsible for the re-transmissions at the correct interval.

A large spacing between repeats assumes that the first message is acceptable most of the time, and therefore allows double the number of messages to be sent in the same period for faster system responses. Repeated messages are simply executed a second time in the responder units. If the message does not change the condition, no new data is recorded. In the case of relative stepping commands, the repeated commands simply step the level accordingly.

The Message Frame format can be as follows in one preferred embodiment of the invention:

| D11 | D10 | D9 . . . D0 | D11 . . . D0 | D7 . . . D0 |
|---|---|---|---|---|
| Dir | 8 Unit/Group | Address | Cmd/Data | Chksum |
| 0 = power line | 0 = unit adr | Unit or group | Command and | 8 bit sum of |
| modem to | 1 = group adr | address | data, per definitions | Dir, unit/grp, |
| responder. | | | following | Adr, and |
| 1 = responder | | | | command. |
| to power line | | | | |
| modem | | | | |

| | | | |
|---|---|---|---|
| Byte #1 | Byte #2 | Byte #3 | Byte #4 |

The bits indicated are the binary data bits, not including the standard start and stop bits of the asynchronous transmission. At 1200 baud, each message frame can take about 33.33 ms. The repeat message is not sent until approximately 2 seconds later, allowing other multiple messages to be sent in short order, as discussed previously. With each frame taking about 33.33 ms and a delay of about 12.5 ms between frames, up to 22 messages can be sent per second, not including repeats.

A transmission can originate at any time from either the power line modem or a responder. However, certain timing restraints help insure priority within the system. The priorities are set up so that the slave repeater has top priority for re-sending a message frame. Otherwise, the power line modem has top priority. The responders have lowest priority and must wait for a longer quiet period before transmitting. The system restraints are as follows:

| Parameter | Value |
|---|---|
| Data Transmission Rate | 1200 Baud (bits per second) |
| Message Frame repeat spacing | Typ. 2 seconds, defined by host |
| Minimum spacing between relative step | 100 ms (10 steps per second) |
| commands | |
| Number of repeats for all message | Typical 2, but can be host |
| frames | defined |
| Delay after message frame for slave | 10 ms (12 bit times) |
| repeat | |
| Minimum silence before next power | 12.50 ms (15 bit times) |
| line modem transmit | |
| Minimum silence before responder | 15 ms (18 bit times) |
| transmit | |

When a responder unit either has a request such as a light switch change for transmission to the power line modem, or the power line modem has requested data from a responder, the responder shall transmit a message frame in the identical format of the power line modem, except that the direction bit is set. The address shall be the responder unit address. The specific definition of the data and commands are device dependent, although this protocol defines some basic responder commands.

The system of the invention can support an optional slave repeater located at the fringes of the power line modem's range. The purpose of the slave repeater is to re-transmit any messages from the power line modem or a responder from the distant location to expand the system's total range.

The slave repeater receives all messages on the line. It can then automatically re-transmit the message approximately 10 ms after the end of the original message frame. This timing insures that the repeater can transmit before the power line modem or a responder unit transmit another message frame. All responders and the power line modem receive this repeat, including those that are distant from the power line modem.

If a responder properly receives the first transmission, the second is executed but no action is taken. A special case is a relative step command. The responder rejects a second relative command if it is repeated in less than the 100 ms specification. When the power line modem receives the repeated message frame, it discards it since the direction bit is cleared and the message is recognized as a power line modem transmission, not a responder transmission. In practice, the power line modem may not even decode the frame since it begins before the prescribed silence time between power line modem message frames. The timing can be adapted to provide this result.

In one embodiment the data transmitted over the power lines can be sent in standard asynchronous serial format at 1200 baud, with one start bit (0), 8 binary data bits, one stop bit (1), and no parity. This can be transmitted using Amplitude Shift Keying (ASK) wherein the carrier frequency is rapidly turned on and off with each on or off cycle representing data bits. The carrier frequency present can represent a zero data bit, and no carrier frequency can represent a 1. However, the data transmitted over the power lines can encoded in any other manner known to those skilled in the art for transmission over the power lines.

A receiver can use a hardware UART or a software UART. A hardware UART can read three samples in the middle of a bit time and can use the majority vote to determine the bit polarity. Hardware UART's also employ framing error detection. In a software UART, a similar technique can be used. Alternately, a timer can be used to read the spacing of incoming transitions, with the validity of the timing being checked to determine data validity.

Each message frame can have an 8 bit checksum. This is the sum of the three address and command bytes. Alternately, the message frames can have any other checksum or other method of determining whether any bits have been corrupted during transmission. If the checksum or other error detection method determines that the frame is incorrect, the command is not acted upon and is discarded.

If a transmission error occurs, the receiver looks for silence on the transmission line for the predetermined time period. After the period of silence has passed, the receiver begins looking for new messages. The system host computer repeats each message transmission a few seconds later. If the receiver detects an error, the second message frame may be able to be read and acted upon.

The system protocol has several mechanisms to avoid collisions of messages sent simultaneously by several responders or a responder and the power line modem. The primary collision avoidance mechanism in the protocol is the system timing. All devices look for a period of silence before starting a transmission. The timing is set up such that the slave repeater has first priority to re-transmit messages. The power line modem has second priority, and the responders have third priority. The priority is defined by the length of silence the device must wait before transmitting.

Responder transmissions are generally random, due to the random time that a switch change or other event occurs in the responder. In addition, each responder must use a random timing interval after the minimum silence period before starting a transmission. This helps to avoid a situation where several responders begin transmission at the same time after the transmission line is silent. This time period is defined according to the requirements of the responder devices, but can range from the base 15 ms wait period to 40 ms, in 5 ms steps.

The receivers of all devices in the system, including the host computer and the responders, monitor the data they transmit with their own receivers. If the data received does not match the data they transmitted, a collision is occurring. All devices abort the transmission and wait for the prescribed silence periods before retrying. This may also avoid noise interference from outside sources.

The set command accommodates most commercial power control applications, especially for lighting control. Each command can be transmitted either from the power line modem to the responder or responder to power line modem. This expands the command set and helps in pre-defining certain actions within the system.

For example, the “ON” or “OFF” command is not only used to turn a light on or off, but may also be sent from a remote light switch to the power line modem when the switch position is changed. The power line modem can then determine which lights are associated with that switch and transmit the appropriate commands to change the lights. Depending on the embodiment, the power line modem can also pass the “ON” or “OFF” command through to the system host computer for decisions.

In addition to the basic commands, several data commands are included in order to accommodate items such as reading the present lighting level of a remote device or reading the temperature of a room. If a remote contains an ambient light level sensor, the number of lights can be automatically adjusted throughout the day according to the sunlight available.

The top two bits of the command define the type of command as follows:

| Command Group Type | D11 | D10 |
|---|---|---|
| General Control | 0 | 0 |
| Scene Assignment, Data | 0 | 1 |
| Transmissions | | |
| Assign to Group | 1 | 0 |
| Remove from Group | 1 | 1 |

The following is a description of the commands that the system obeys.

| D11 | D10 | D9 . . . D6 | D5 . . . D0 |
|---|---|---|---|
| 0 | 0 | 0 0 0 0 | Level Value (0-63) |

The Go To Level Absolute command causes the responder to change its level instantly to the requested level represented in the 6 bit data field. The number of levels is 64. The receiver shall limit the final value to the maximum range.

| D11 | D10 | D9 . . . D6 | D5 | D4 . . . D0 |
|---|---|---|---|---|
| 0 | 0 | 0 0 0 1 | Up(0), Down (1) | Step Size |

The Go To Level Relative command causes the responder to step up or down a number of steps relative to its current level. The step size is defined by a signed value in the data field, where a negative value has bit 5 set and a positive value has bit 5 cleared. The receiver shall limit the final value to the maximum range.

| D11 | D10 | D9 . . . D6 | D5 . . . D0 |
|---|---|---|---|
| 0 | 0 | 0 0 1 0 | Level Value |

The Fade To Level Absolute command causes the responder to fade to the designated level in the previously set fade time.

| D11 | D10 | D9 . . . D6 | D5 . . . D0 |
|---|---|---|---|
| 0 | 0 | 0 0 1 1 | Fade Time |

Sets the fade time in terms of 1/10 of a second (100 ms). Affects all subsequent “Fade To Level Absolute” commands. It also affects all subsequent “Assign to Scene” commands. A fade time of zero causes an instantaneous level change. Note that fades will occur in the time requested regardless of the level change requested, compensated for level. The time may vary somewhat.

| D11 | D10 | D9 . . . D6 | D5 . . . D0 |
|---|---|---|---|
| 0 | 0 | 0 1 0 0 | 1 1 1 1 1 1 |

Power On turns on the power relay in the responder. The light level is not affected. It may also be used by a remote light switch to indicate the status of a switch.

| D11 | D10 | D9 . . . D6 | D5 . . . D0 |
|---|---|---|---|
| 0 | 0 | 0 1 0 1 | 0 0 0 0 0 0 |

Power Off turns off the power relay in the responder. The light level is not affected. It may also be used by the remote light switch to indicate the status of a switch.

| D11 | D10 | D9 . . . D6 | D5 . . . D0 |
|---|---|---|---|
| 0 | 0 | 0 1 1 0 | Minimum Level (0-63) |

The Set Minimum Value Command sets the minimum level according to the 6 bit data value. All subsequent GO TO LEVEL, GO TO SCENE, and FADE TO LEVEL commands limit their actions to this value.

| D11 | D10 | D9 . . . D6 | D5 . . . D0 |
|---|---|---|---|
| 0 | 0 | 0 1 1 1 | Maximum Level (0-63) |

The maximum or “On” level is set according to the 6 bit data value by Set Maximum Value. All subsequent SET LEVEL, ON, GO TO SCENE, and FADE TO LEVEL commands limit their actions to this value.

| D11 | D10 | D9 . . . D6 | D5 . . . D0 |
|---|---|---|---|
| 0 | 0 | 1 0 0 0 | 1 0 0 1 1 0 |

The Set Address command is only used in conjunction with the program button. The user first presses the program button. The next “Set Address” command seen on the line will set that responder to the address in the Set Address command. Only one responder should be placed in program mode at a time, unless several responders are intended to be programmed to the exact same address. The data field contains a fixed key code that must match in order for the address to be changed.

If the responder has bi-directional capability, this command may be used to identify the current responder address. The responder will transmit a message frame to the power line modem with this command when the program button is pushed, identifying the device and flagging that a change has been requested.

| D11 | D10 | D9 . . . D6 | D5 . . . D0 |
|---|---|---|---|
| 0 | 0 | 1 0 0 1 | Data Type |

This Request Data command is a power line modem command that requests that a specific responder unit transmit a data frame and return a specific type of data as defined by the data field. This may be useful for periodic polling of devices such as remote temperature sensors, light sensors, or heating units. The data type is device specific. Codes “0 0 1 0 1 0” thru “0 0 1 1 1 1” are available for use within the system for future use. (6 codes total).

| D11 | D10 | D9 . . . D7 | D6 . . . D0 |
|---|---|---|---|
| 0 | 1 | 0 0 0 | Scene Number |

When the Go To Scene command is received, the responder checks its scene list. If the scene is on the list, the responder retrieves the data for the scene, including level and fade rate, and acts on it. Each responder can be assigned to 24 scenes in one embodiment of the invention.

| D11 | D10 | D9 . . . D7 | D6 . . . D0 |
|---|---|---|---|
| 0 | 1 | 0 0 1 | Scene Number |

The Assign To Scene command causes the responder to record the current level and most recent fade time, including instant on or off actions, along with the scene number. If there is no space left in the responder scene list, the command is ignored.

| D11 | D10 | D9 | D8 | D7 | D6 . . . D0 |
|---|---|---|---|---|---|
| 0 | 1 | 0 | 1 | 0 | Scene Number |

The responder removes the indicated scene number from its list. Note that an entire scene setting among multiple units can be erased by sending this command to the global address (all units) when the Remove From Scene command is received.

| D11 | D10 | D9 | D8 | D7 | D6 . . . D0 |
|---|---|---|---|---|---|
| 0 | 1 | 0 | 1 | 1 | 0 1 0 0 1 1 0 |

The Remove From All Scenes command causes the responder to remove all scene numbers from its list. Note that all scene settings in the system can be erased by sending this command to the global address (all units).

| D11 | D10 | D9 | D8 | D7 . . . D0 |
|---|---|---|---|---|
| 0 | 1 | 1 | 0 | Data |

The Send Data A command sends the primary data from the responder to the power line modem. In future devices, it may also send special configuration data to a responder. This can provide specialized commands beyond the scope of the standard command set. This command may be sent in response to a power line modem “Request Data” or independently when a certain event within the responder occurs.

| D11 | D10 | D9 | D8 | D7 . . . D0 |
|---|---|---|---|---|
| 0 | 1 | 1 | 1 | Data |

The Send Data B command is identical to Send Data A, but sends a second byte of data, possibly representing a second piece of information about the responder. If the data was requested, the power line modem will expect the second command frame with the second data byte, if the device has been defined that way.

| D11 | D10 | D9 . . . D0 |
|---|---|---|
| 1 | 0 | Group Address |

The responder addressed is assigned to the group according to the 10 bit data field. Each responder can be included in up to 24 groups by the Assign To Group command in one embodiment of the invention.

| D11 | D10 | D9 . . . D0 |
|---|---|---|
| 1 | 1 | Group Address |

The addressed responder is removed from the group by the Remove From Group command. This command is useful for situations such as office re-modeling. In addition, an entire group structure can be cleared by sending this command to the group to be deleted. All units in the group are removed from the group.

| D11 | D10 | D9 . . . D0 |
|---|---|---|
| 1 | 1 | 1 1 1 1 1 1 1 1 1 1 |

The addressed responder clears all group assignments when it receives the Remove From All Groups command. This command will be useful for “cleaning up” a device before reprogramming. Note that ALL group addressing can be reset by using this command addressed to all units (global address).

### DETAILED DESCRIPTION OF THE PREFERRED EMBODIMENT

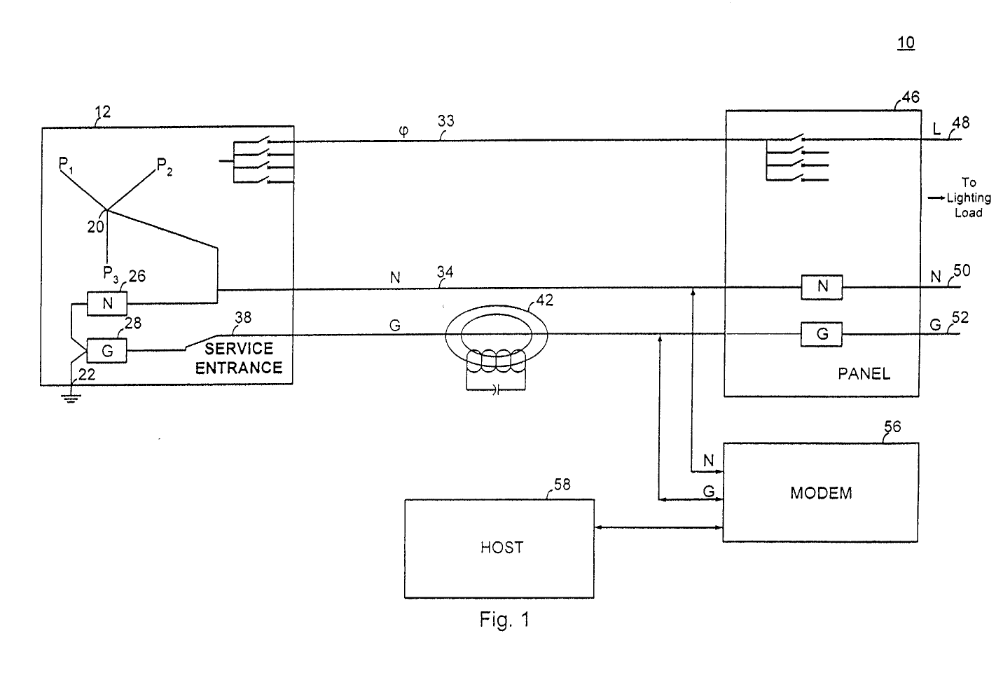

Referring now to FIG. 1, there is shown the electrical load controller 10 of the present invention for controlling electrical loads, for example, electrical lighting loads within a building. Within the electrical load controller 10 a service entrance 12 receives power in a conventional manner from an electrical utility company for the purpose of energizing electrical loads within the building where the electrical load controller system 10 performs the methods of the present invention.

The service entrance 12 is adapted to provide a three phase electrical signal for energizing the loads in the building, phases P₁, P₂ and P₃. The ground 20 of the phases P₁, P₂ and P₃is connected to a neutral conductor 34 and to a neutral junction point 26 or neutral bus bar 26 in a conventional manner. Furthermore, a conventional ground junction point 28 or ground bus bar 28 is coupled to a service entrance ground 22 as well to the neutral junction point 26 to thereby provide an earth ground and a ground conductor 38 for applying energy to loads external to the service entrance 12. The service entrance ground 22 can be formed in accordance with the NEC250 standard of the U.S. National Electric Code. A typical grounding scheme is described in IEEE Standard 1100-1992, Powering and Grounding Sensitive Electrical Equipment.

One of the three phases P₁, P₂ or P₃ of the service entrance 12 is coupled to the circuit breakers 32. For illustrative purposes, a selected circuit breaker within the circuit breakers 32 is connected to apply energy to loads external to the service entrance 12 under the control of the electrical load controller system 10 of the present invention. The selected circuit breaker is connected to the output of the service entrance 12 by way of a φ conductor 33.

In one preferred embodiment of the electrical load controller system 10, a tuned current transformer 42 is coupled to the ground conductor 38. The tuned current transformer 42 can be formed of a parallel resonant circuit consisting of a transformer self-inductance and shunt capacitor which are turned to the center frequency of the modem depicted in FIG. 1. Alternately, the tuned current transformer 42 can be formed according to any other standard known by those skilled in the art to be suitable for the purposes described with respect to the tuned current transformer 42. Without the tuned current transformer 42 the impedance between the neutral conductor 34 and the ground conductor 38 would be close to zero ohms. The tuned current transformer 42 is provided to increase the impendence of the ground conductor 38 at a predetermined tuned frequency, while maintaining the very low impendence in the frequency range of 50 to 60 hertz. This prevents the impressed signal from being applied back into the service entrance 12.

The impedance provided by the tuned current transformer 42 permits the carrier frequency of an information modulation method to be impressed onto the conductors 34, 38 while not causing interference between the tuned current transformer 42 and the energy being applied to the loads by the conductors 33, 34 and 38. The information modulation method used within the electrical load controller 10 can be Amplitude Shift Keying, Frequency Shift Keying, or any other information modulation method known to those skilled in the art.

In an alternate embodiment of the invention, an inductor (not shown) can be inserted in series with the ground conductor 38 rather than using the tuned current transformer 42. Such an inductor in the path of the ground conductor 38 could perform the same operations as tuned current transformer 42 by providing the high impendence path in the ground conductor 38 at the tuned frequency while maintaining the low impendence in the frequency range of 50 to 60 hertz.

The conductors 33, 34 and 38, connected to the service entrance 12 as previously described for applying energy to loads external to the service entrance 12, are also connected to an electrical panel 46. A line conductor 48, a neutral conductor 50, and a ground conductor 52, corresponding, respectively, to the φ conductor 33, the neutral conductor 34, and the ground conductor 38, are provided at the output of the electrical panel 46 for energizing the electrical loads in the building.

The electrical load controller 10 of the present invention is provided with a host computer 58. The host computer 58 is responsible for performing the control protocols and other operations of the present invention. For example, the host computer 58 can control the selective dimming and turning on and turning off of a plurality of lighting loads in a building. It can also receive and process sensor information from various points in the building. Thus, the host computer 58 can implement predetermined algorithms such as timed control of load energization and shedding algorithms.

The host computer 58 is coupled by way of a bidirectional bus 57 to a host computer modem 56. The transmit information applied to the bidirectional bus 57 by the host computer 58 includes the control information necessary for controlling the loads, wherein the transmit information is associated with an address corresponding to the load to be controlled. Additionally, receive information is applied by the bidirectional bus 57 to the host computer 58, wherein the receive information includes the address of the sensor sending the receive information as well as the sensor output data.

When the host computer modem 56 receives the transmit control information from the host computer 58 it reformats the information. The host computer modem 56 then applies the reformatted information between the neutral conductor 34 and the ground conductor 38. Impressing the reformatted control information between the neutral conductor 34 and the ground conductor 38 results in the control information being present between the neutral conductor 50 and the ground conductor 52 when energy is applied to the regions of the building where the loads reside.

In this manner, the transmit information of the system of the present invention is impressed between the neutral conductor 34 and the ground conductor 38, rather than between the Line (L) and the Neutral (N) conductors of the branch wiring. Transmitting the information signal between the neutral conductor 34 and the ground conductor 38 rather than between the Line (L) and the Neutral (N) provides substantially improved noise performance in the electrical load control system 10. For example, information transmission has improved noise immunity. The present invention provides a much more efficient, load-invariant impedance match of modem signals into the controlled branch circuit and it simultaneously couples a common control signal to all secondary phases (e.g. P₁, P₂ & P₃) of the transformer in the service entrance 12.

Additionally, return information can be transmitted from loads being energized in accordance with the method of the present invention to the host computer 58 by way of the host computer modem 56. The receive control information transmitted from the loads to the host computer 58 in this manner is impressed between the neutral conductor 50 and the ground conductor 52. The control information received by the host computer 58 in this manner is impressed between the neutral conductor 34 and the ground conductor 38. The receive information transmitted in this manner is obtained from the conductors 34, 38 by the host computer modem 56 for reformatting and transmission to the host computer 58 by way of the bidirectional data bus 57.

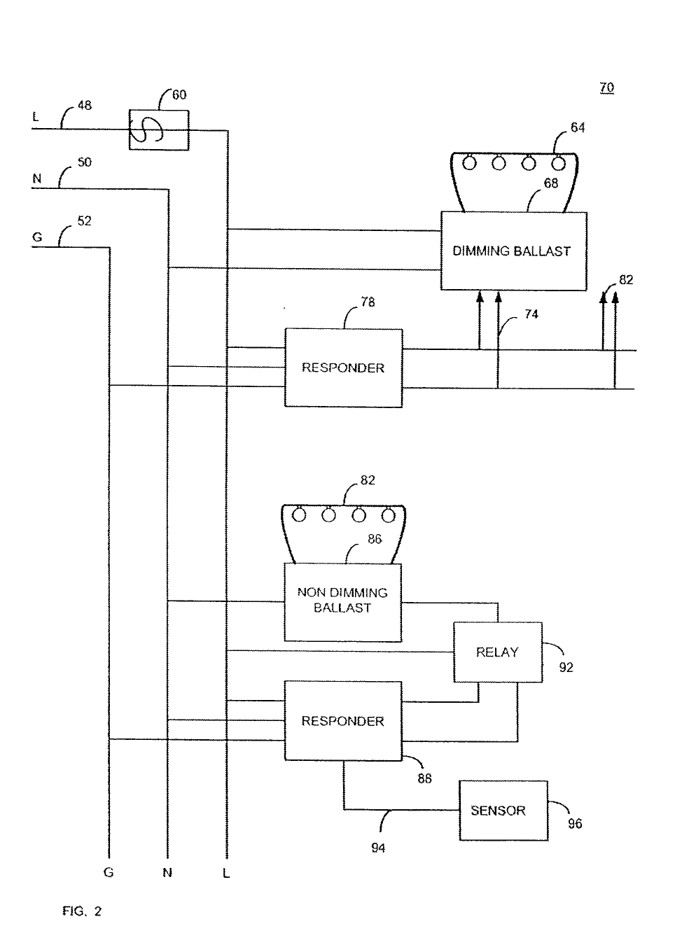

Referring now to FIG. 2, the line conductor 48, the neutral conductor 50, and the ground conductor 52 from the electrical panel 46 are applied to application circuitry 70. Within the application circuitry 70 an on/off switch 60 can be provided for opening and closing the path of the line conductor 48, thereby permitting or preventing the application of energy from the service entrance 12 to the application circuitry 70. In other embodiments of the invention, occupancy sensors, time switches, remote control devices, or any other kind of control device can be inserted into the line conductor 48 in place of the on/off switch 60 to control the application of energy to the application circuitry 70.

The line conductor 48 and the neutral conductor 50, along with the control information transmitted by the host computer 58 impressed therebetween, are applied to a dimming ballast 68. The dimming ballast 68 can be any commercially available fluorescent ballast (e.g. Advance Transformer Mark VII series) that utilizes a 0-to-10 volt D.C. control interface to set the dimming level. In addition to fluorescent fixtures, other types of light sources such as High Pressure Sodium and Mercury Halide Lamp fixtures equipped with dimming ballasts could also be controlled by this system.

The output of the dimming ballast 68 is used to drive a load, such as a lighting load 64. In the preferred embodiment of the invention the lighting load 64 can be one or more fluorescent lighting tubes 64. In this manner it is possible for the electrical load control device 10 to control the level of lighting emitted from the flourescent lighting tubes 64 without causing any changes in the power factor of the application circuitry.

It will be understood by those skilled in the art that there is a non linear relationship between the energy applied to the flourescent lighting load 64 while being adjusted by the dimming ballast 68 and the light energy emitted from the flourescent lighting load 64. In particular, if the power applied to the flourescent lighting load 64 is reduced a predetermined percentage, then the light emitted therefrom is reduced by a percentage greater than the predetermined percentage.

The line conductor 48, the neutral conductor 50, and the ground conductor 52 are applied to a carrier signal responder 78. This permits the carrier signal responder 78 to receive the transmit control information applied by the host computer 58 to the neutral conductor 34 and the ground conductor 38 by way of the host computer modem 56. The carrier signal responder 78 then determines whether the address information received in this manner is its own address according to the signals impressed between the conductors 50, 52.

If the correct address information is found the carrier signal responder 78 controls the dimming ballast 68 by way of the dimming ballast control lines 74 based upon the transmit control information transmitted by the host computer 48. In the preferred embodiment of the invention, the control of the dimming ballast 68 by way of the dimming ballast control lines 74 can be performed using a conventional 0 to 10 volt DC dimming control system. Thus, the responder 78 applies a control voltage level to the dimming ballast 68 which is determined according to the host computer 58 transmit control information is received by the responder 78 from the neutral conductor 50 and the ground conductor 52.

In accordance with the method of the present invention the carrier signal responder 78 can be adapted to recognize a programmed address selected out of a plurality of different possible addresses. The programmed address to be recognized by the carrier signal responder 78 can be predetermined or it can be determined at the time of the installation of the carrier line responder 78 using push buttons, switches, plug ins, or any other programming method known to those skilled in the art. Furthermore, the address of the carrier signal responder 78 can be changed by host computer 58.

Transmit control information from the host computer 58 for controlling the load of the carrier line responder 78 is associated with the predetermined address by the host computer 58. Thus, when the host computer 58 addresses a selected responder 78, the host computer 58 places the address of the selected responder 78 in association with the information for controlling the load of the selected responder 78 onto the conductors 34, 38 by way of the host computer modem 56. A responder 78 only controls its load in accordance with transmit control information from the host computer 58 when it detects its own address in the transit information. Furthermore, it will be understood by those skilled in the art that any number of responders can be adapted to respond to the same address from the host computer 58.

A number of other ballasts and other lighting loads, in addition to the load 64, can be controlled by the same selected carrier signal responder 78 by way of the control leads 82 which are coupled to the output of the carrier line responder 78. If the control leads 82 are coupled to a further load, such as a further fluorescent tube (not shown), the further load is controlled in the same manner as the load 64 according to the same transmit control information from the host computer 58. Thus, any number of different loads within the application circuitry 70 can be grouped to be controlled by the host computer 58 by way of a single address.

A carrier line responder 88 is also provided within the electrical load control system 10 of the present invention. The carrier line responder 88 can respond to an address that differs from the address of the carrier line responder 78. Furthermore, the carrier line responder 88 can control a non dimming ballast 86 or a step dimming ballast 86, and thereby the fluorescent tubes 82 coupled thereto, in accordance with transmit control information associated with that address by the host computer 58 and applied to the neutral conductor 34 and the ground conductor 38 by way of the host computer modem 56. The carrier line responder 88 can control the non dimming ballast 86 ballast 86 by way of an electrode mechanical relay 92 or a solid state relay 92.

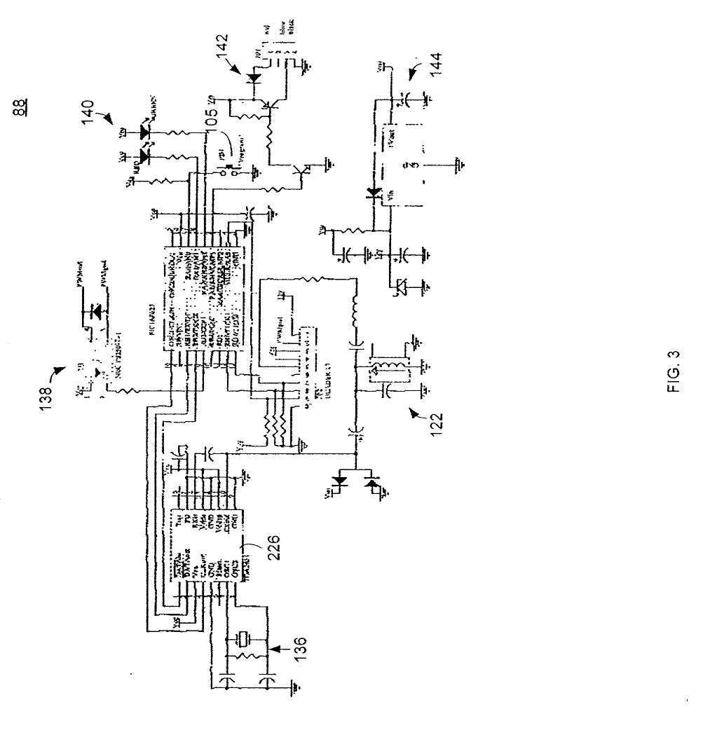

Referring now to FIG. 3, there is shown a more detailed representation of the responder 88 shown in FIG. 2. A further block diagram level discussion of the responder 88 is provided with respect to FIG. 5.

In the responder 88 a band pass filter 122 receives the signal transmitted by way of conductors 50, 52 and applies it to a modem 126. The modem 126 can be the TDA5051 modem chip from Phillips semiconductor for converting incoming ASK or PSK data. Additionally, the modem 126 can be any other kind of modem chip suitable for receiving and extracting the transmitted control information.

The data in and out of the modem chip is coupled to a microprocessor 134. A timing circuit 136 can provide the timing for both the modem 126 and the microprocessor 134. Status indicators 140 can be provided to the responder 88 in order to permit the microprocessor 134 to indicate the status of the operations within the responder 88.

The microprocessor 134 can control, for example, a dimming ballast using pulse width modulated signals transmitted from the microprocessor 134 by way of an optical isolator 138. Additionally, the microprocessor 134 can control and on off power relay by way of relay control circuitry 142. The responder 88 is energized by a power supply 144 and can be programmed by a programming push button 105 as will be described in more detail later.

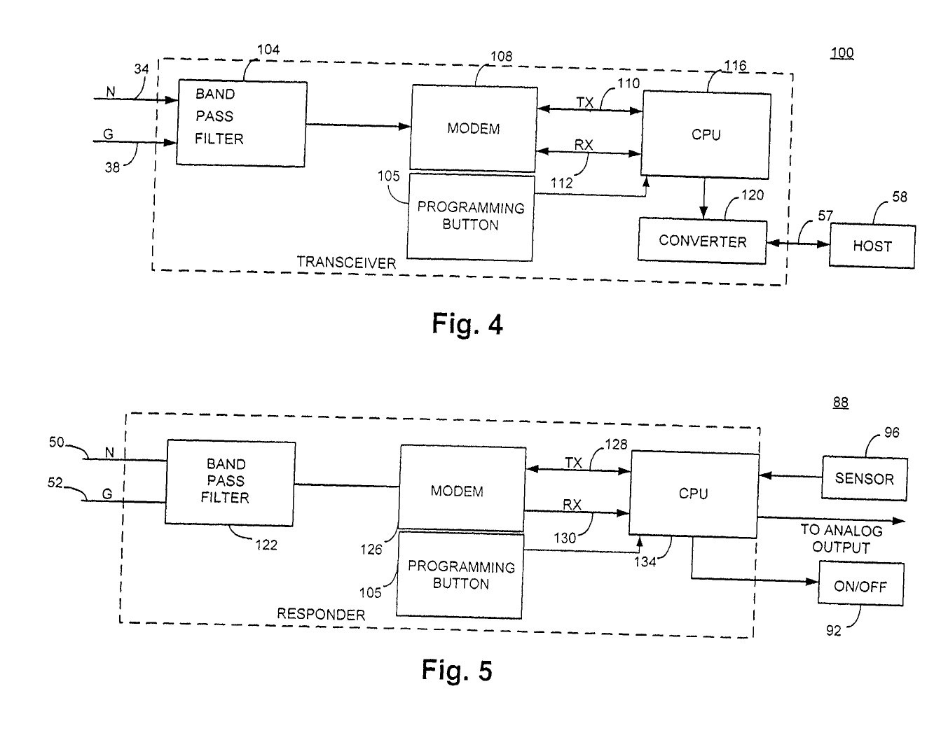

Referring now to FIG. 4, there is shown a carrier line transceiver 100 The carrier line transceiver 100 is suitable for transmitting information between the conductors 34, 38 and the host computer 58 within the electrical load controller 10.

Within the carrier line transceiver 100 the neutral conductor 34 and the ground conductor 38 are applied to a bandpass filter 104. The bandpass filter 104 is selected to pass the carrier line frequencies carrying information between the host computer 58 and the application circuitry 70,. The bandpass filter 104 is also selected to block frequencies other than the carrier line frequencies, especially 50 to 60 hertz. The receive information from the application circuitry 70 is extracted from the conductors 34, 38 in this manner by the bandpass filter 104 and applied to the modem circuitry 108.

The receive information from the bandpass filter 104 is received by the modem circuitry 108 is reformatted by the modem circuitry 108. The reformatted receive information is applied by way of the receive line 112 to the transceiver microprocessor 116 for processing operations such as determining the address information transmitted from the application circuitry 70 between the neutral conductor 34 and the ground conductor 38. The transceiver microprocessor 116 communicates this receive information to the host computer 58 by way of the converter 120 and the bidirectional bus 57. In this manner address recognition, memory, timing and generation of PWM dimming control signals are controlled.

When the host computer 58 transmits information to the application circuitry 70, the transmit information is received from the host computer 58 by the converter microprocessor 116 by way of the bidirectional bus 57 and the converter 120. Information and applied to the modem circuitry 108 by way of the transmit line 110. The transmit information from the transceiver microprocessor 116 is transmitted to the modem circuitry 108 by way of the transmit line 110. The transmit information from the modem circuitry 108 is received by the bandpass filter 122 and impressed between the neutral conductor 34 and the ground conductor 38 for transmission to the application circuitry 70.

Referring now to FIG. 5, there is shown a more detailed representation of the carrier line responder 88. As previously described, the carrier line responder 88 receives transmit control information by way of the conductors 34, 38 and the conductors 50, 52. The information impressed on the conductors 34, 38, 50, 52 is passed by bandpass filter 122 of carrier line responder 88. The filtered information signal is applied to modem circuitry 126. Information from the host computer 58 is then applied by way of transmit line 128 to microprocessor 134. The microprocessor 134 must then determine whether the address information received from the host computer 58 is its own address. If so, it can then control either a dimming ballast or a relay as previously described.

The microprocessor 134 within the carrier line responder 88 also receives input from the sensor 96. The microprocessor applies the information received from the sensor 96 to the modem circuitry 126 by way of receive line 130. Modem circuitry 126 then impresses the information upon the conductors 50, 52 in order to permit the host computer 58 to receive the information along with the address of the transponder 88.

Note that transceiver 100 and the responder 88 include a programming pushbutton 105 for indicating to CPU 118, 134 respectively that a new unit or group address assignment is to be accepted. When the next SET ADDRESS command is received by a unit after depression of programming pushbutton 105, the new address within the SET ADDRESS command is stored by the CPU 118, 134. This is very useful during installation, replacement or future relocation. It can be used to document the geographical location of a responder by, for example, providing communication between someone installing a responder and someone who knows the address being stored by the CPU 118, 134, thereby permitting the two pieces of information to be associated with each other.

Without further elaboration the foregoing will so fully illustrate my invention that others may, by applying current or future knowledge, adopt the same for use under various conditions of service.

We claim:

1. In a system including a plurality of energy dissipating loads a method for controlling from a location remote from a load of said plurality of loads the amount of electrical energy applied to said load wherein load control information is transmitted between said remote location and said load by way of a plurality of electrical energy transmission lines including a neutral conductor, a ground conductor and a line conductor, comprising the steps of:
(a) determining load control information representative of said energy applied to said load;
(b) applying said load control information to said energy transmission lines at an impressing end of said energy transmission lines for transmission to a receiving end of said energy transmission lines wherein said load control information is impressed between said neutral conductor and said ground conductor of said energy transmission lines to provide impressed load control information;
(c) receiving said impressed load control information at said receiving end of said energy transmission lines by obtaining said load control information from between said neutral conductor and said ground conductor to provide received load control information; and
(d) controlling said energy of said load in accordance with said received load control information.

2. The energy control method of claim 1, wherein said impressing end of said plurality of electrical energy transmission lines includes a host computer for performing control protocols to control the energy dissipation of said load.

3. The energy control method of claim 2, wherein said receiving end of said plurality of energy transmission lines includes a responder for obtaining said impressed load control information to obtain said load control information, comprising the further step of providing a control voltage signal by said responder for controlling said energy dissipative of said load in accordance with said load control information.

4. The energy control method of claim 3, comprising the further step of applying said control voltage signal to a dimming ballast for controlling the energy applied to a lighting fixture.

5. The energy control method of claim 3, comprising the further step of applying said control voltage signal to an on/off relay for controlling operation of a lighting fixture.

6. The energy control method of claim 1, wherein said impressing end of said plurality of energy transmission lines includes a responder comprising the further step of receiving a load status signal by said responder representative of a status associated with said load.

7. The energy control method of claim 6, wherein said receiving end of said plurality of energy transmission lines comprises a host computer for performing the control protocols to control the energy of said load.

8. The energy control method of claim 7, wherein said receiving end of said plurality of energy transmission lines further comprises a sensor for sensing said status associated with said load and applying said load status signal representative of said status to said responder.

9. The energy control method of claim 8, wherein said sensor comprises a temperature sensor.

10. The energy control method of claim 1, wherein a selected load of said plurality of loads has load address information, comprising the steps of:
(a) associating at said impressing end of said plurality of electrical energy transmission lines said load address information with said load control information for controlling said energy applied to said selected load;
(b) applying said load control information and said associated load address information to said plurality of energy transmission lines;
(c) receiving said load control information and said associated load address information at said receiving end of said plurality of energy transmission lines to provide said received load control information and received associated load address information; and
(d) controlling said selected load in accordance with said received load control information and said received associated load address information.

11. The energy control method of claim 10, wherein single load address information is associated with a plurality of differing loads for controlling the loads of said plurality of differing loads in accordance with said single load control information.

12. The energy control method of claim 10, including a plurality of differing loads having respective differing load address information and respective associated load control information for controlling the energy applied to the differing loads comprising the further step of controlling a selected load of said plurality of differing loads only when its respective load address information is associated with said respective load control information.

13. The energy control method of claim 1, wherein said impressing end of said energy transmission lines and said receiving end of said energy transmission lines are disposed in a single building.

14. The energy control method of claim 1, wherein said impressing end of said energy transmission lines and said receiving end of said energy transmission lines are disposed in differing buildings.

15. The energy control method of claim 1, wherein said load control information is impressed between said neutral conductor and said ground conductor of said energy transmission lines by means of a modem.

16. The energy control method of claim 1, wherein said impressed load control information is obtained from between the said neutral conductor and said ground conductor of said energy transmission lines by a modem.

17. The energy control method of claim 1, wherein said system is provided with electrical energy from a distribution transformer and said impressing end of said energy transmission lines and said receiving end of said energy transmission lines are both disposed on a secondary side of said distribution transformer.

18. The energy control method of claim 1, wherein said impressing end of said energy transmission lines receives said load control information by way of an internet connection prior to impressing said load control information between said neutral conductor and said ground conductor of said energy transmission lines.

19. The energy control method of claim 1, comprising the further step of applying a tuned current transformer to said ground conductor.

20. The energy control method of claim 19, comprising the further step of impressing said load control information between said neutral conductor and said ground conductor at a location between said tuned current transformer and said receiving end of said energy transmission lines.

21. A system for controlling from a location which is remote from a load the amount of electrical energy from a service entrance applied to said load wherein energy control information is transmitted between said remote location and said load by way of a plurality of electrical energy transmission lines including a neutral conductor, a ground conductor and a line conductor, comprising:
(a) a first control signal transmission point of said energy transmission lines for impressing said load control information upon said energy transmission lines to provide impressed load control information;
(b) a tuned current transformer applied to said energy transmission lines between said service entrance and said first control signal transmission point for adjusting the impedance of said energy transmission lines;
(c) a second control signal transmission point of said energy transmission lines for obtaining said load control information from said energy transmission lines to provide received load control information; and
(d) a responder for controlling said energy of said load in accordance with said received load control information.

22. The system of claim 21, wherein said energy control information is provided with a carrier signal and said tuned current transformer is tuned to the frequency of said carrier signal.

23. The system of claim 22, wherein said tuned circuit transformer provides a high impedance path for transmission of said energy control information into said service entrance.

24. The system of claim 23, wherein said tuned circuit transformer is applied to said ground conductor of said energy transmission lines.

25. The system of claim 24, wherein tuned circuit transformer is applied to said energy transmission lines independently of any connections to said neutral conductor or said line conductor.

26. The system of claim 25, wherein said load control information is impressed between said neutral conductor and said ground conductor.
